(19) United States
(12) Patent Application Publication
(10) Pub. No.: US 2024/0162644 A1
(43) Pub. Date: May 16, 2024

(54) CONDUCTIVE TERMINAL

(71) Applicant: YAO-MING LU, New Taipei City (TW)

(72) Inventor: YAO-MING LU, New Taipei City (TW)

(21) Appl. No.: 18/229,100

(22) Filed: Aug. 1, 2023

(30) Foreign Application Priority Data
Aug. 5, 2022 (TW) 111129651

(51) Int. Cl. H01R 13/04

(52) U.S. Cl. CPC H01R 13/04

(57) ABSTRACT

A conductive terminal features a wire positioning structure and a solder guiding structure. This design allows it to be used for positioning a conductive wire and a guiding solder material towards the conductive wire, enabling the soldering of the conductive wire to the conductive terminal. This innovation addresses the challenge of soldering the conductive wire to the miniaturized conductive terminal. Therefore, the conductive terminal presented in this application can be made miniaturized and is suitable for use in size-constrained electrical connectors, contributing to the development of slim and lightweight electronic products.

### CROSS-REFERENCE TO RELATED APPLICATIONS

This application claims the priority of Republic of China Patent Application No. 111129651 filed on Aug. 5, 2022, in the State Intellectual Property Office of the R.O.C., the disclosure of which is incorporated herein by reference.

### BACKGROUND OF THE INVENTION

### Field of the Invention

This application relates to a conductive terminal, specifically, a conductive terminal capable of positioning conductive wires and guiding the flow of solder material.

### Descriptions of the Related Art

Electronic products are usually provided with electrical connectors and conductive wires, wherein the conductive wires are soldered to the conductive terminals of the electrical connectors to provide electrical signal transmission through the conductive terminals of the electrical connectors. In recent years, electronic products have a development trend of light, thin, and small, resulting in limited internal space for electronic products. It limits the size of electrical connectors used in electronic products. Therefore, the designs of the conductive terminals are gradually introduced into miniaturization. However, the smaller the conductive terminal is, the more unfavorable it is for welding conductive wires.

Based on the foregoing, how to solve the problem that miniaturized conductive terminals are unfavorable for soldering conductive wires has become a technical issue that is of urgent concern to those in the technical field.

### SUMMARY OF THE INVENTION

Given the shortcomings of the above-mentioned prior art, the present application provides a conductive terminal, which is used in conjunction with a conductive wire and a solder material. The conductive terminal includes: a left blade, which comprises a left blade body and a left extension wing that extends from the left blade body towards the left; a right blade, which comprises a right blade body and a right extension wing that extends from the right blade body towards the right; and a blade joining body that joins the left blade and the right blade, positioning them side by side to form an extension wing assembly where the left extension wing and the right extension wing are adjacent. The extension wing assembly has a wire positioning structure and a solder guiding structure. The wire positioning structure provides positioning for the conductive wire, while the solder guiding structure guides the solder material, directing it towards the conductive wire positioned by the wire positioning structure. to allow the conductive wire to be soldered to the conductive terminal using the solder material.

Preferably, in the conductive terminal of the present application, the extension wing assembly has a T-shaped cross-section.

Preferably, in the conductive terminal of the present application, the extension wing assembly has a slot, which comprises a slot bottom and a slot wall. The wire positioning structure is located at the slot bottom, and the solder guiding structure is positioned on the slot wall, which extends to the slot bottom, to guide the flow of the solder material towards the slot bottom.

Preferably, in the conductive terminal of the present application, the slot wall has an inclined guiding surface, which is provided to guide the flow of the solder material towards the slot bottom.

Preferably, in the conductive terminal of the present application, the slot wall has a curved guiding surface, which is provided to guide the flow of the solder material towards the slot bottom.

Preferably, in the conductive terminal of the present application, the left blade and the right blade have the same structure.

Preferably, in the conductive terminal of the present application, it is further in conjunction with a conductive component wherein the left blade also has a left joining structure, and the right blade also has a right joining structure. When the left blade and the right blade are arranged side by side, the left joining structure and the right joining structure are adjacent to form a joining structure assembly. This joining structure assembly is used for joining the conductive component.

Preferably, in the conductive terminal of the present application, the joining structure assembly has a rectangular cross-section.

Compared to prior art, the provided conductive terminal in this application includes a wire positioning structure and a solder guiding structure that enable the positioning of a conductive wire and guide solder material towards the conductive wire for soldering the conductive wire to the conductive terminal. This addresses the issue of soldering the conductive wire to the miniaturized conductive terminal Therefore, the conductive terminal of the present application allows for the miniaturization of the conductive terminal and is particularly beneficial for electronic connectors with size constraints, enabling the use of electronic products with a slim and lightweight design.

### BRIEF DESCRIPTION OF THE DRAWINGS

The above and other aspects, features and other advantages of the present invention will be more clearly understood from the following detailed description taken in conjunction with the accompanying drawings, in which:

FIG. 1 is a three-dimensional schematic diagram of the embodiment of the conductive terminal in the present application.

FIG. 2 is a three-dimensional schematic diagram of the embodiment of the conductive terminal in the present application.

FIG. 3 is a side view diagram of some components of the embodiment of the conductive terminal in the present application.

FIG. 4 is a top view diagram of some components of the embodiment of the conductive terminal in the present application.

FIG. 5 is a bottom view diagram of some components of the embodiment of the conductive terminal in the present application.

FIG. 6 is a rear view diagram of some components of the embodiment of the conductive terminal in the present application.

FIG. 7 is a front view diagram of some components of the embodiment of the conductive terminal in the present application.

FIG. 8 is a front view diagram of some components of the embodiment of the conductive terminal in the present application.

FIG. 9 is a front view diagram of some components of the embodiment of the conductive terminal in the present application.

FIG. 10 is a front view diagram of some components of the embodiment of the conductive terminal in the present application.

### DETAILED DESCRIPTION OF THE PREFERRED EMBODIMENT

Embodiments of the present invention will now be described in detail with reference to the accompanying drawings. The invention may, however, be embodied in many different forms and should not be construed as being limited to the embodiments set forth herein. Rather, these embodiments are provided so that this disclosure will be thorough and complete, and will fully convey the scope of the invention to those skilled in the art.

This application provides a conductive terminal that can be used to position a conductive wire and guide a solder material toward the conductive wire, enabling the soldering of the conductive wire to the conductive terminal. This addresses the issue of difficulties in soldering the conductive wire to the miniaturized conductive terminal.

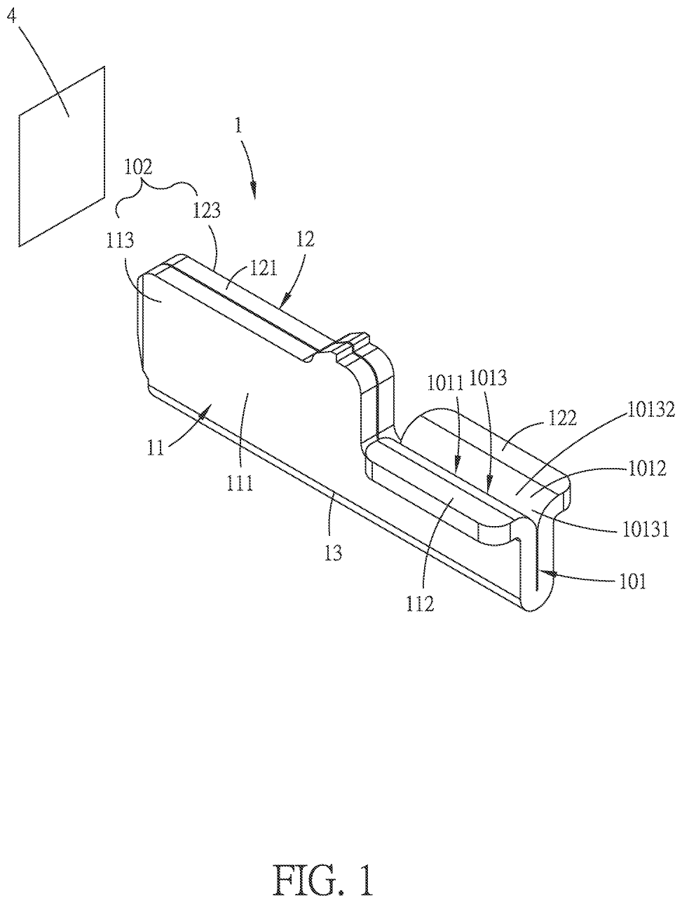

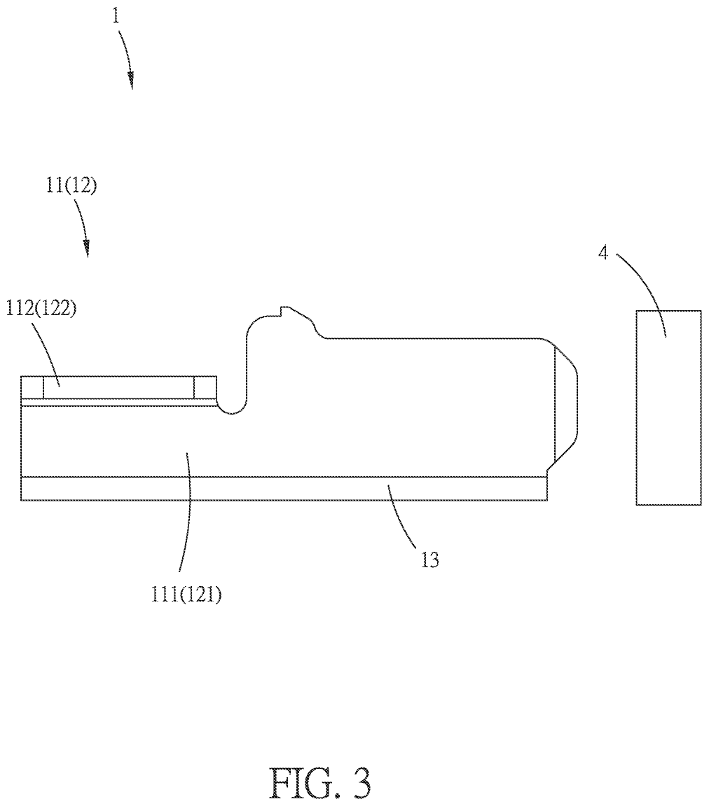

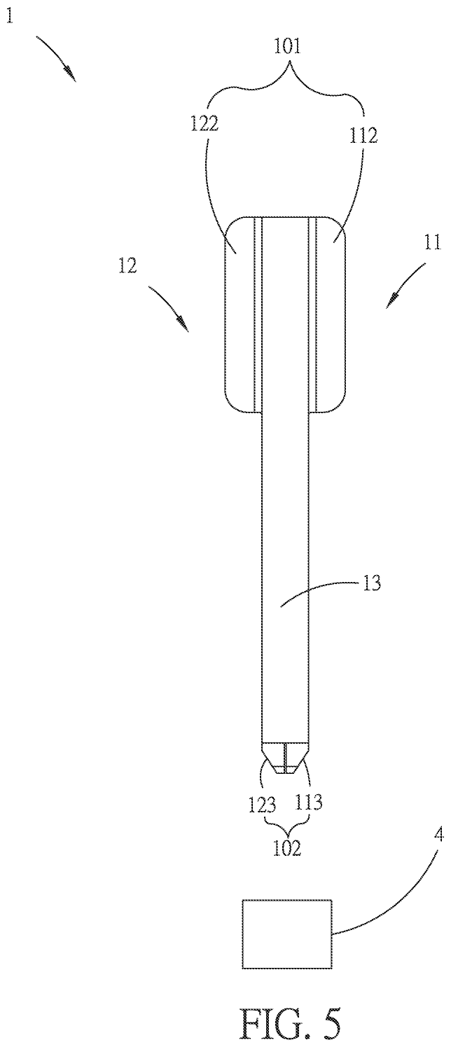

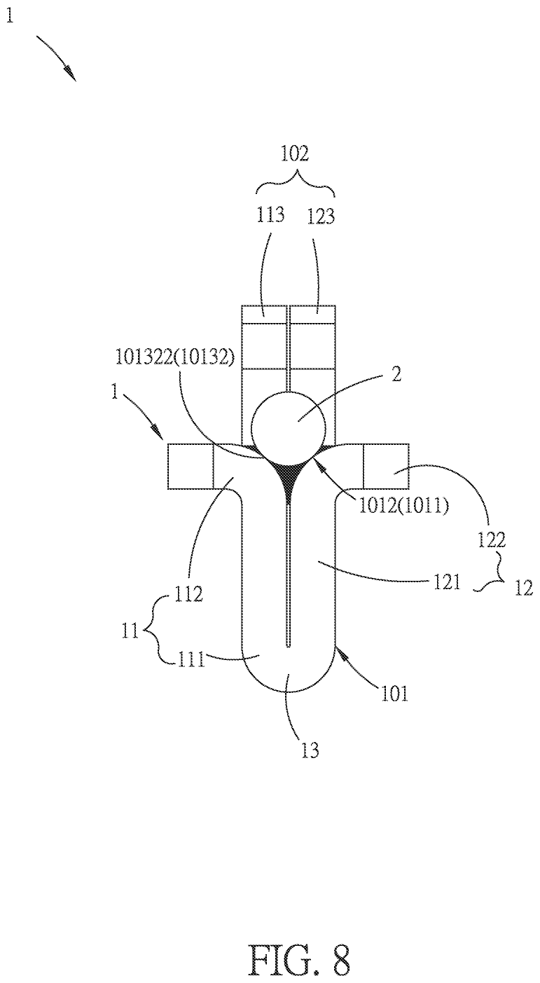

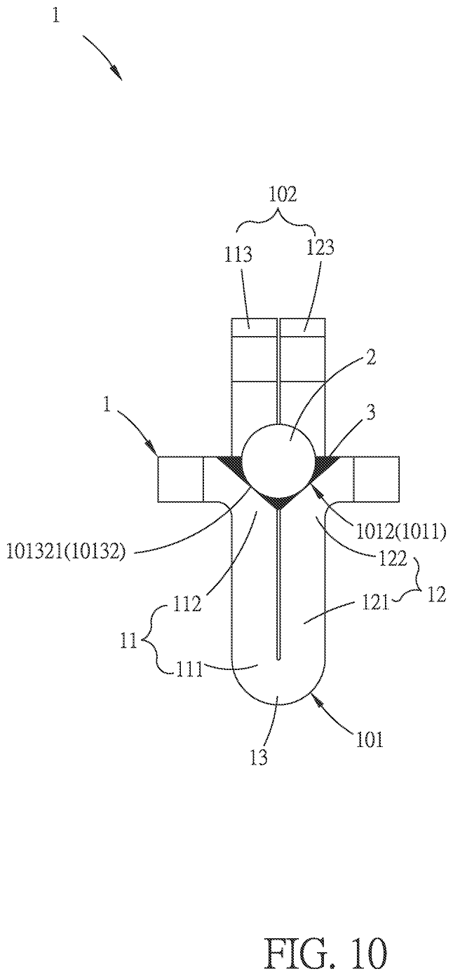

Technical features of the conductive terminal according to the present application are described with reference to FIGS. 1 to 10 and the following embodiments.

In the embodiments shown in FIGS. 1 to 10, the conductive terminal 1 is used in conjunction with a conductive wire 2, a solder material 3, and a conductive component 4. The conductive terminal 1 comprises a left blade 11, a right blade 12, and a blade joining body 13.

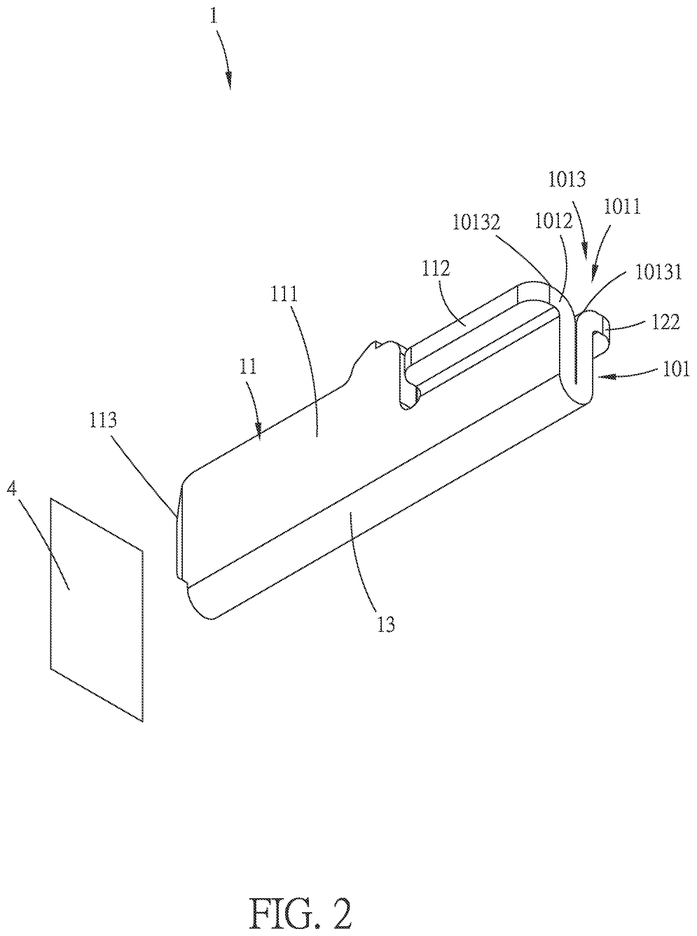

As shown in FIGS. 1 and 2, the left blade 11 comprises a left blade body 111, a left extension wing 112, and a left joining structure 113. The right blade 12 comprises a right blade body 121, a right extension wing 122, and a right joining structure 123. The left extension wing 112 extends from the left blade body 111 towards the left side, while the right extension wing 122 extends from the right blade body 121 towards the right side, meaning that the left extension wing 112 and the right extension wing 122 extend in different directions.

The blade joining body 13 is joined to the left blade 11 and the right blade 12, thereby constraining the relative positions of the left blade 11 and the right blade 12 to align the left blade 11 and the right blade 12 side by side, allowing the left extension wing 112 and the right extension wing 122 to be adjacent to each other, forming an extension wing assembly 101.

As shown in FIGS. 1 and 2, the left joining structure 113 and the right joining structure 123 are adjacent to each other and form a joining structure assembly 102 when the left blade 11 and the right blade 12 are arranged side by side. The joining structure assembly 102 provides for the connection of the conductive component 4 to transmit electrical signals.

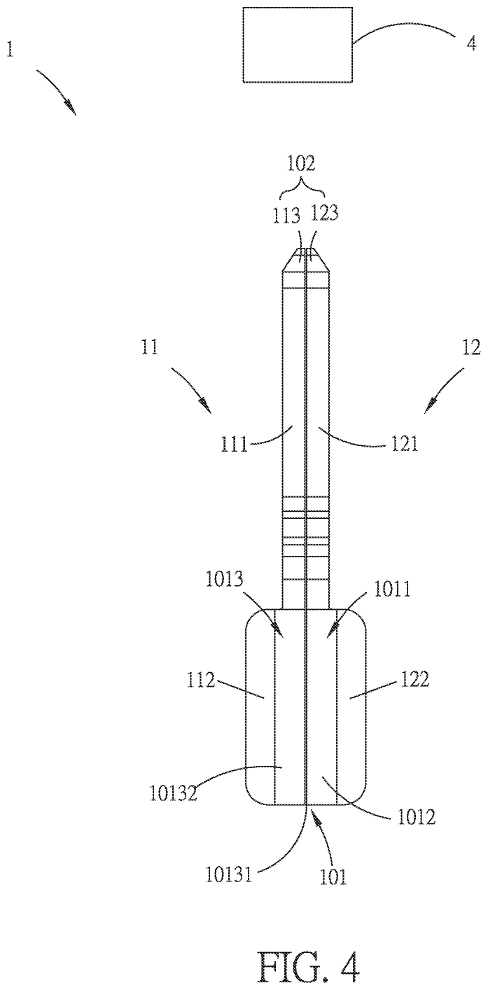

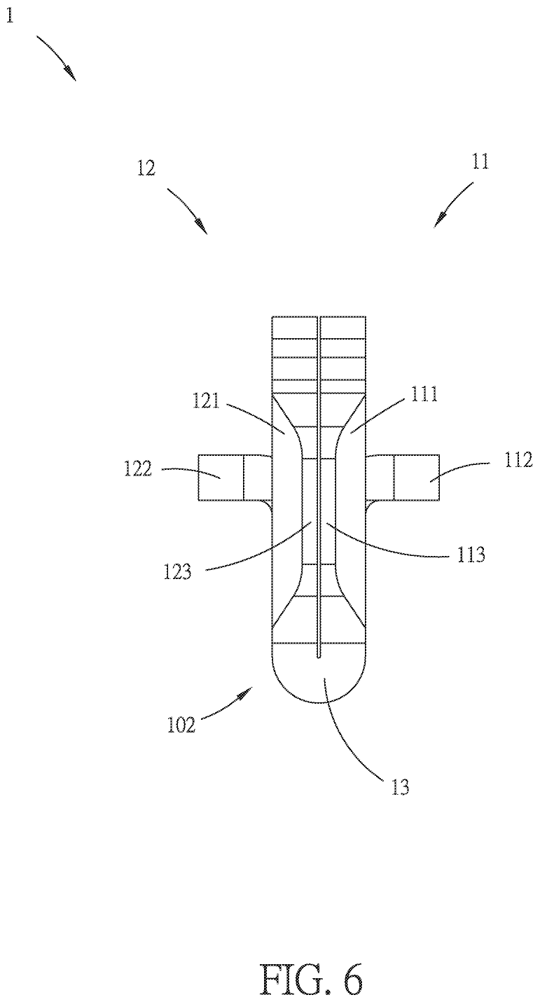

It should be noted that in the embodiments shown in FIGS. 4 and 6, the structures of the left blade 11 and the right blade 12 are the same. Therefore, the joining structure assembly 102 has a rectangular cross-section to accommodate the design of the joining structure of the conductive component 4.

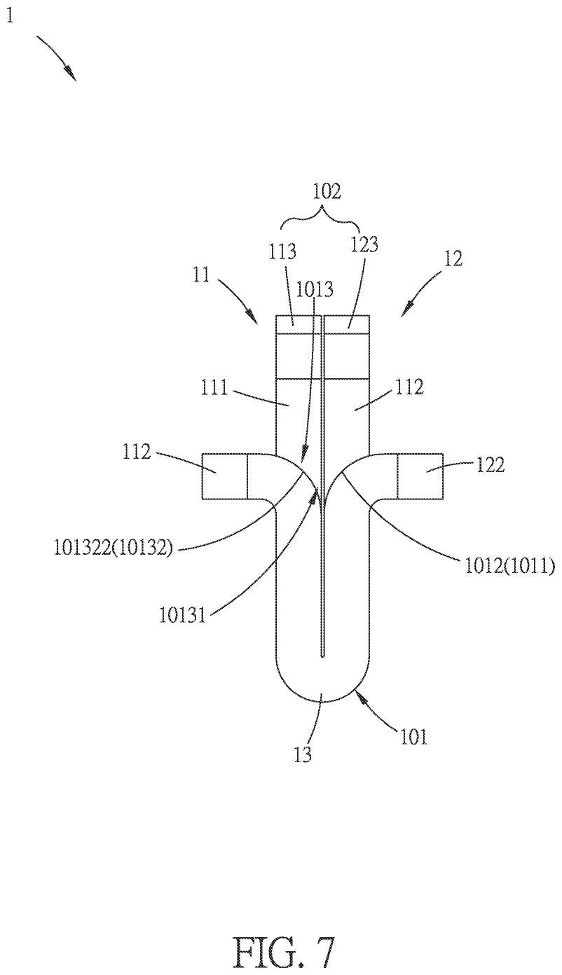

In the embodiments shown in FIGS. 7 to 10, the structures of the left blade 11 and the right blade 12 are the same, allowing the extension wing assembly 101 to have a T-shaped cross-section, providing positioning for the conductive wire and guiding the flow of the solder material.

It should be noted that the extension wing assembly 101 has a wire positioning structure 1011 and a solder guiding structure 1012. The wire positioning structure 1011 provides positioning for the conductive wire 2. The solder guiding structure 1012 guides the solder material 3, directing it towards the conductive wire 2 positioned by the wire positioning structure 1011, enabling the solder material 3 to solder the conductive wire 2 to the conductive terminal 1.

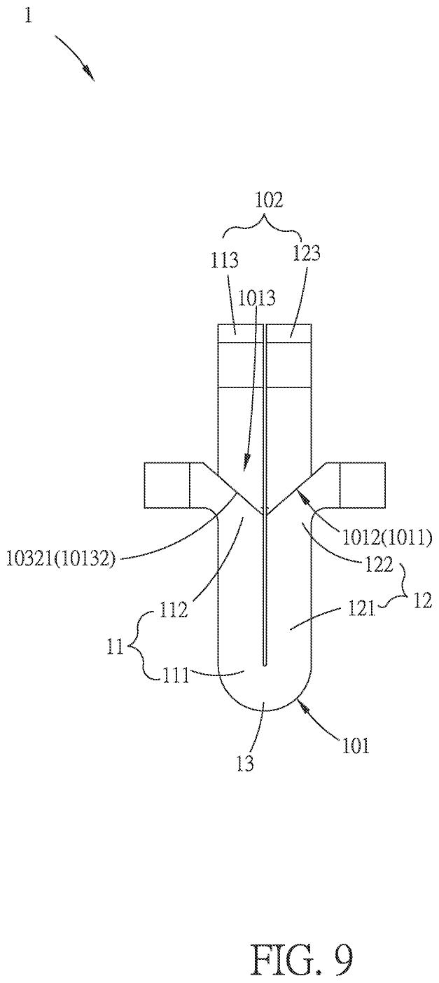

As shown in the embodiment in FIG. 1, the extension wing assembly 101 has a slot 1013, where the slot 1013 consists of a slot bottom 10131 and a slot wall 10132. In the above-mentioned embodiment, the wire positioning structure 1011 is located at the slot bottom 10131, and the solder guiding structure 1012 is positioned at the slot wall 10132. It should be noted that, as shown in the embodiment in FIG. 9, the slot wall 10132 has a sloping guiding surface 101321 extending towards the slot bottom 10131. In the embodiment shown in FIG. 7, the slot wall 10132 has a curved guiding surface 101322 extending towards the slot bottom 10131. In this way, the slot wall 10132 can guide the solder material 3 to flow towards the slot bottom 10131 and make contact with the conductive wire 2, which is positioned at the slot bottom 10131 by the wire positioning structure 1011. This allows the solder material 3 to solder the conductive wire 2 to the conductive terminal 1, addressing the issue of soldering the conductive wire to the miniaturized conductive terminal.

It should be noted that the conductive terminal described in this application can also omit certain components, and is not limited to the embodiments described above. For example, the conductive terminal in this application may choose to include only the following components: a left blade, a right blade, and a blade joining body. The left blade has a left blade body and a left extension wing, where the left extension wing extends from the left blade body towards the left. The right blade has a right blade body and a right extension wing, where the right extension wing extends from the right blade body towards the right. The blade joining body is joined to the left blade and the right blade, positioning them side by side, allowing the left extension wing to be adjacent to the right extension wing, forming an extension wing assembly. The extension wing assembly has a wire positioning structure and a solder guiding structure. The wire positioning structure provides positioning for the conductive wire, and the solder guiding structure guides the solder material, directing it towards the conductive wire positioned by the wire positioning structure. This facilitates soldering the conductive wire to the conductive terminal using the solder material.

In summary, the conductive terminal described in this application features a wire positioning structure and a solder guiding structure, enabling to be used for positioning a conductive wire and guiding a solder material towards the conductive wire to solder the conductive wire to the conductive terminal. This innovation addresses the challenge of soldering the conductive wire to the miniaturized conductive terminal. Therefore, the conductive terminal presented in this application can be made miniaturized and is suitable for use in size-constrained electrical connectors, contributing to the development of slim and lightweight electronic products.

The examples above are only illustrative to explain principles and effects of the invention, but not to limit the invention. It will be apparent to those skilled in the art that modifications and variations can be made without departing from the spirit and scope of the invention. Therefore, the protection range of the rights of the invention should be as defined by the appended claims.

What is claimed is:

1. A conductive terminal, which is equipped with a conductive wire and a solder material, comprising:
a left blade including a left blade body and a left extension wing, wherein the left extension wing extends to the left from the left blade body;
a right blade including a right blade body, and a right extension wing extending to the right from the right blade body;
a blade joining body joining to the left blade and the right blade, allowing the left blade and the right blade to be side by side and allowing the left extension wing and the right extension wing to be adjacent to form an extension wing assembly,
wherein the extension wing assembly includes a wire positioning structure providing the positioning for the conductive wire and a solder guiding structure providing the guiding for the solder material, allowing the solder material to flow to the conductive wire positioned by the wire positioning structure and allowing the conductive wire can be soldered to the conductive terminal by the solder material.

2. The conductive terminal of claim 1, wherein the extension wing assembly includes a T-shaped section.

3. The conductive terminal of claim 1, wherein the extension wing assembly includes a slot having a slot bottom and a slot wall,
wherein the wire positioning structure is located on the slot bottom, and the solder guiding structure is located on the slot wall,
wherein the slot wall is extended to the slot bottom to guide the solder material to flow to the slot bottom.

4. The conductive terminal of claim 3, wherein the slot wall includes a sloping guiding surface, which guides the solder material to flow to the slot bottom.

5. The conductive terminal of claim 3, wherein the slot wall includes a curved guiding surface, which guides the solder material to flow to the slot bottom.

6. The conductive terminal of claim 1, wherein the structures of the left blade and the right blade are the same.

7. The conductive terminal of claim 1, further equipped with a conductive component,
wherein the left blade includes a left joining structure, and the right blade includes a right joining structure,
wherein the left joining structure is adjacent to the right joining structure to form a joining structure assembly when the left blade is side by side with the right blade, and the joining structure assembly provides to join the conductive component.

8. The conductive terminal of claim 7, wherein the joining structure assembly includes a rectangular section.
